(19) United States
(12) Patent Application Publication
(10) Pub. No.: US 2018/0070545 A1
(43) Pub. Date: Mar. 15, 2018

(54) Ventusponic automated hydroponic plant growth apparatus and method

(71) Applicant: Joseph G. Komor, Palm Harbor, FL (US)

(72) Inventors: Stanley J. Perry, Sarasota, FL (US); Joseph G. Komor, Palm Harbor, FL (US)

(21) Appl. No.: 15/261,967

(22) Filed: Sep. 11, 2016

(51) Int. Cl. A01G 31/02; A01G 1/00

(52) U.S. Cl. CPC A01G 31/02; A01G 1/001

(57) ABSTRACT

The Ventusponic automated hydroponic system is a hydroponic plant apparatus and method divided by a passive and/or mechanical internal fan, with intent to create a higher velocity wind, utilizing spaced holes formed therethrough. The system is driven by the apparatus of an electrical fan as the means of delivering oxygen and water. Achieved by wind flowing in a helical circular pattern there through a vacuum flow in the grow chambers. The use of wind in a helical flow pattern allows for an even distribution of the elements oxygen and water. This is provided by the aforementioned spiral drilled holes on the grow chambers and an inline fan that allows the wind with the elements to pass in a circular pattern. Roots develop into a hollow cylinder shaped structure with or without the use of any support or medium. Providing a higher surface area, rendering for the elements to easily pass thru the grow chamber reducing the possibility of an anaerobic environment and creating a de-elevated growth duration, with higher quantifiable yield.

### FIELD OF INVENTION

The invention relates to hydroponics apparatus and method for the production of one or more plants. The system and method is designed to facilitate the ability of maximizing root absorption for increasing plant growth.

### BACKGROUND OF THE INVENTION

Background of the invention relates to the apparatus and method of growing with improvements to the delivery of water oxygen and nutrients to plant roots. As well as venting and cooling, providing faster growth, healthier plants and increase yield of high quality plants.

The present day hydroponic, aeroponic have been successful in the past, but with some limitation and need for improvements. The necessary improvements are focus on the delivery process of water, oxygen, and nutrients to plant roots. As well as cooling, venting, gas reduction, oxygen improvement and lower cost. Improvements of the development of roots in cylinder shape structure without support or medium improve plant intake and reduces the chance of an anaerobic environment.

The current technology in hydroponics uses water as the primary means for delivering oxygen, water and nutrients. The following are examples of current technology of systems or methods.
1. Ebb n flow—the flooding of trays with medium
2. Deep water culture—Styrofoam sheets or panels place on a solution with oxygen being provided an air stone or bubbler.
3. Drip system—drip lines running to each plant that are in pots, troughs or beds with a medium.
4. NFT—troughs or tubes having a film of nutrient rich solution passing along the bottom of system.
5. Aeroponics—plants suspended in a system with a mist spraying roots. With most systems using a small amount of medium.
6. Fog—plants suspended in a system with a fine mist provided by a fogger.

The necessary changes that are being made are as follows:
1. Increasing oxygen, water and nutrient uptake by plants.
2. Reduction of the possibility of over saturation of roots by solution.
3. Venting and air exchange of gas build up and fresh air in grow chambers.
4. Cooling of air and water in grow chambers.
5. Eliminating the need for system dependency of chillers to reduce temperature.
6. Reduces the amount of misters and water used.
7. Development of a superior root formation.

This is all achieved by the primary component of wind that travels in helical or circular pattern via a vacuum and the simultaneous use of inline fan with misters, along with spiral drilled grow chambers.

Ventusponics has made changes to hydroponics that provides many benefits for indoor or outdoor use, or for hobbyist and professionals. With the use of a wind operated system or method will increase yields and provide healthier plants. The said system and method uses less water and reduces the amount of waste water. This is beneficial during time of water conservation and waste into water ways reducing pollution. The said system and method provides a superior root formation for more efficient means of delivery of elements and reduces the opportunity of anaerobic environment.

### SUMMARY

Ventusponics automated hydroponic plant growth apparatus and method is a system for using a inlaid fan within a growth chamber. It uses wind delivery as a means to transporting oxygen, water and nutrients. Also preventing roots being over saturated, which could pose problems for some plants making more diverse and plant friendly

The current invention eliminates the limitations that have plagued existing systems or methods by
1. Reducing buildup of gases which raise temperature and has low oxygen which kills or slow plant growth.
2. Cooling of solution and air in grow chamber without the need of a chiller, with the misters and wind flash cooling chambers on a regular bases.
3. Objective of root development is to provide a cylinder structure for the ease of transporting of water oxygen, water and nutrient; reducing the possibility of an anaerobic environment.
4. Reduces the amount of water needed for operation due to the use of wind for the delivery. This result in less run off and need for water changes and waste water.

The system may be used by hobbyist or professionals for growing of a large variety of plants for profit or personal use, and may be expanded to accommodate more plants.

### BRIEF DESCRIPTION OF DRAWING

FIG. 1 is a detail top plan, looking down

FIG. 2 is a detail side view

FIG. 3 is a detail front view

FIG. 4 is a detail back view

FIG. 5 is a detail of the power unit

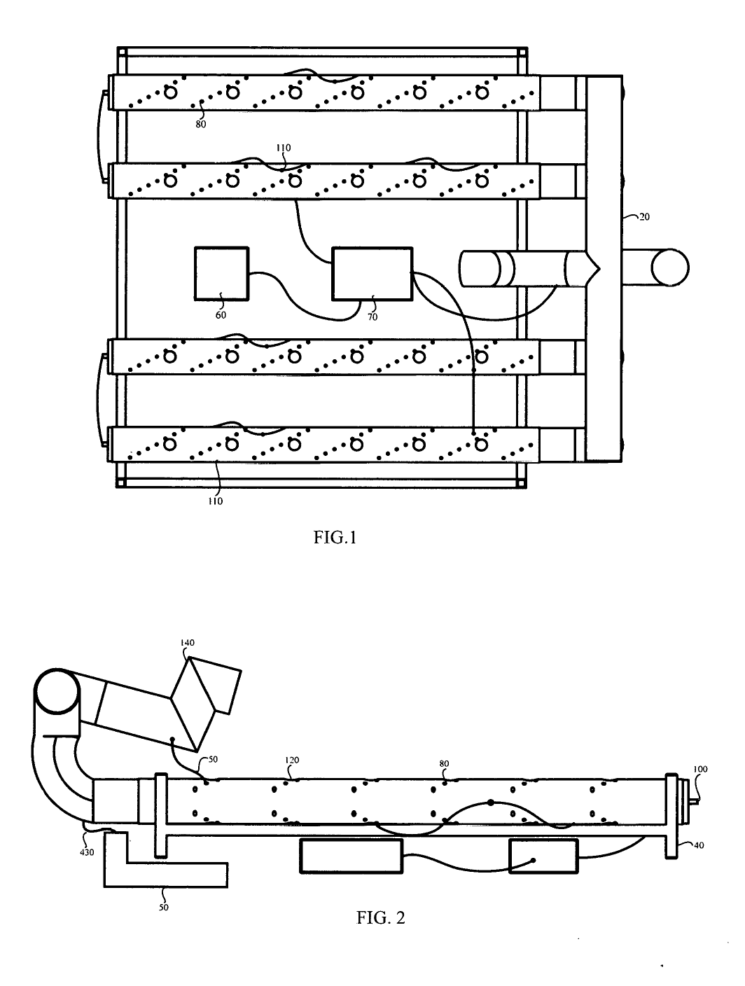

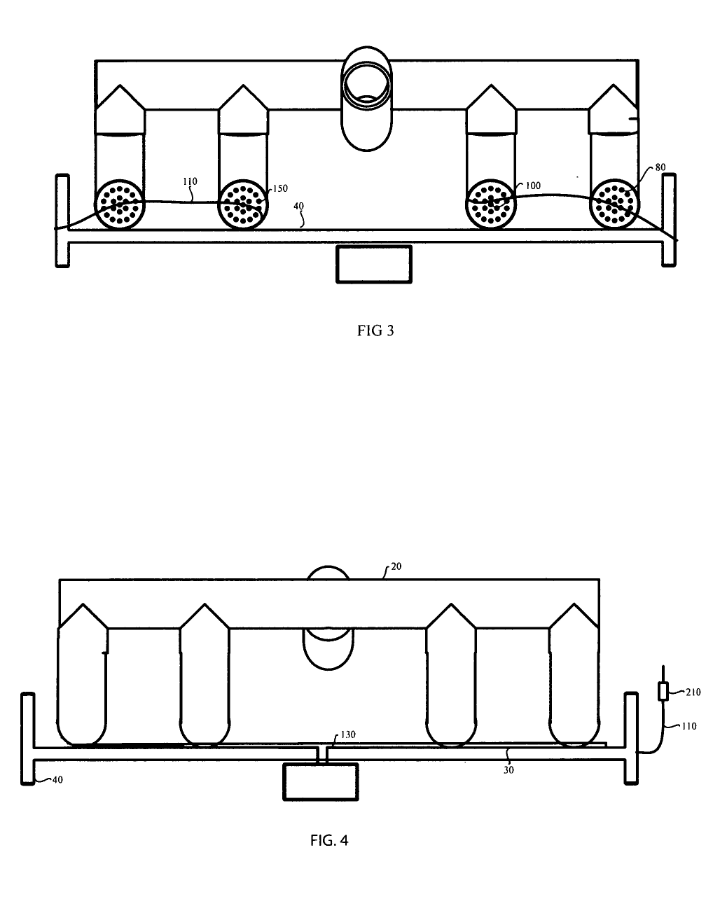

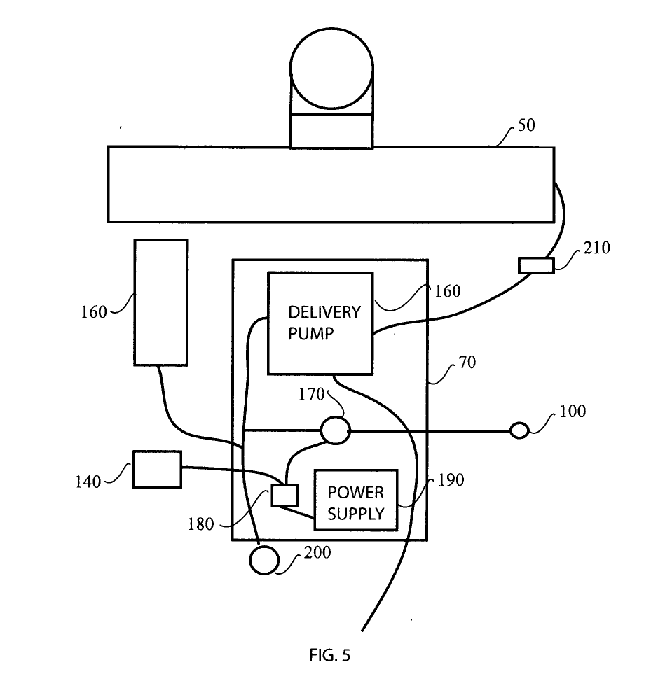

### DETAILED DESCRIPTION OF INVENTION

The Ventusponics grow system 1000 consist of grow chambers 10 that attach to an exhaust manifold 20 and drain line 30. This sits on a stand 40 with a T shape reservoir 50, pressure tank 60 and control unit 70.

The grow chamber 10 has vent holes 80 that are spiral drilled covering 310 degrees allowing an area for any run off. The spiral drill vent holes 80 on grow chambers 10 result in a circular flow of wind. At one end of the grow chamber 10 is an end cap 90 with vent holes 80 and a mister/fogger with fitting and rubber grommet 100. The mister/foggers 100 are connected by a water line 110 that runs along the grow chamber 10 to the end cap 90; the distance is determined by spacing of the plant site 120.

Each plant site 120 contains a basket with a collar or cover, which aides in preventing vacuum loss and proper distribution of wind. At the other end of the grow chambers 10 is the drain line 30 and exhaust manifold 20. The drain line 30 is connected to each grow chamber 10 and the exhaust manifold drain 130, and then runs to the reservoir 50 for return of any run off.

The exhaust manifold 20 connects to each grow chamber 10, which also has an inline fan 140 and ends at an exhaust cover 150 with vent holes 80. The exhaust manifold 20 regulates wind flow and collection of water. The control unit 70 operates the system which contains a delivery pump/booster pump and pressure solenoid 160, off/on shut off solenoid 170, timer 180, power supply 190, and pressure gauge 200.

A solution runs from the reservoir 50 thru a water line 110 to a strainer/filter 210; the water line 110 continues to the delivery pump 160 which fills the pressure tank 60 and pressure gauge 200. Then the water line 110 runs to the off/on shut off solenoid 170 which controls the flow of solution; when turned on runs solution thru water line 110 to each mister/fogger 100.

The timer 180 controls the timing of inline fan 140 and shut off solenoid 170 so when operated together with the vent holes 80 will provide the circular flow pattern of the wind providing the oxygen, water and nutrients as well as venting and cooling for plant roots.

1. A method of using inlying fan with exterior holes therethrough for plant growth, comprising of:
a) Providing said inlaid fan, passive and/or mechanical, delivers air and/or solution to plants within the growth chamber,
b) Holes on the exterior of growth chamber to allow for ventilation of contents of said chamber, and
c) Providing an internal and/or external pump, rather passive and/or mechanical, delivering water to the said inlaid fan for distribution throughout the chamber respectively.

2. The apparatus and method of claim 1 where in comprises of an inline fan and/or exhaust manifold and/or similar venturi-effect for the transportation of water and oxygen.

3. The apparatus and method of claim 1 where in comprises of mister or foggers for spraying micro particles of solution to the growth chamber

4. The apparatus and method of claim 1 where in comprises of plant securing devices to secure plant to growth chamber apparatus to prevent vacuum loss.

6. The apparatus and method of claim 1 where oxygen is drawn from the designated input(s) of air, in manifold method or other, and exit in the designated area(s), in manifold method or other.

7. The apparatus and method of claim 1 where a manifold connects one or more grow chambers for ventilation for exhaust of air and/or solution.
